(19) United States
(12) Patent Application Publication
(10) Pub. No.: US 2021/0370631 A1
(43) Pub. Date: Dec. 2, 2021

(54) LIFT AND TILT DEVICE, BALER EQUIPPED THEREWITH AND METHOD OF ITS OPERATION

(71) Applicant: Hermann Schwelling, Salem (DE)

(72) Inventor: Hermann Schwelling, Salem (DE)

(21) Appl. No.: 17/331,711

(22) Filed: May 27, 2021

(30) Foreign Application Priority Data
May 28, 2020 (DE) 102020114354.0

(51) Int. Cl. B30B 9/30; B65G 67/04; B65G 67/30

(52) U.S. Cl. CPC B30B 9/301; B65G 67/30; B65G 67/04

(57) ABSTRACT

In that the lifting and tilting device (22)—which can be used as a separate assembly or integrated in or on a baler (1) for lifting up and tilting out a collector trolley (SW)—consists of only one long pivot arm (30) and a tilting part (31) tiltably attached thereto, the tilting movement of which is controlled by a link guide (33), a very stable, structurally simple and purely mechanical device can be achieved, as well as a baler (1) equipped therewith.

### I. FIELD OF APPLICATION

The invention relates to a lift-and-tilt device by means of which containers open at the top can be lifted up and emptied by tilting, usually into a filling opening located at a high level

### II. TECHNICAL BACKGROUND

A typical application for this are baling presses into which materials to be pressed, for example packaging materials such as cardboards, films or flattened beverage containers, must be fed via such a filling opening as a filling opening for the most automated feeding possible of such a baling press.

For this purpose, lift-tilt devices are often used, into which a collector trolley open at the top and filled with the corresponding materials to be compressed is moved, which is then first brought to the height of the filling opening by means of this lift-tilt device and is emptied by tilting into the filling opening. The filling opening is generally located above the bale chamber of the baler, and thus—depending on its size—at or above head height.

The problem here is that the available headroom above the filling opening is limited, and so during emptying the collector trolley should rise as little as possible from the filling opening.

For this reason, lift-and-tilt devices are known in which the collector trolley is attached to the free end of a pivot arm, which can be pivoted about a horizontal axis, by means of a fixing device, whereby a certain movement path of the fixing device and thus of the collector trolley when it is emptied is achieved by either the pivot arm being embodied in several parts, in particular comprising a 4-hinge linkage.

Guiding the fixing device by means of a link guide is also known, but not by means of a pivot arm.

Furthermore, the problem exists that the floor space required for approaching and inserting the collector trolley into the mounting device of the lift-and-tilt device should be as small as possible next to the actual baler in order to keep the overall floor space required for the operation of the baler to a minimum.

In the case of balers, a distinction must be made between so-called box balers and channel balers.

In the case of box balers, the material to be baled is pressed against the bottom of the baling box by a press plunger which is usually vertically movable—whose removal opening, located in one of the vertical side walls of the baling box, is closed during operation by a removal door, which is opened to remove the finished bale.

In channel balers, the press plunger is usually horizontally movable and compresses the material in the press box, pushing it out of the press box on the side opposite the press plunger into an adjacent press channel which is permanently open at its open end, the removal opening, but which, due to a tapering of its cross-section in the end region, offers sufficient resistance to the strand pushed through it for pressing. In sections, the resulting compacted strand is divided into bales in the press channel by strapping with a binding material such as wire or plastic straps, which can then be transported away after leaving the removal opening.

In both cases, the filling opening is generally located on the upper side of the baling channel, and in the case of vertical box balers, sometimes also in the upper area of one of the vertical side walls of the baling box.

Smaller vertical-action box balers are often used for low volumes of material to be pressed.

In the case of the smaller box balers, filling and emptying is often carried out from the front of the baler by means of a closable filling opening in the upper part of the front wall, through which the loose material—for example, empty cardboard boxes or empty plastic bottles or beverage cans—is manually filled into the bale chamber when the press plunger is in the upwardly retracted starting position, i.e. above the filling opening.

In order to reduce the manual effort required for filling and also to increase the throughput of such a box baler, it is known to fill it automatically by a conveyor belt transporting loose material deposited thereon to the filling opening and discharging it through this opening into the press chamber when the press plunger is in its starting position above. The conveyor belt usually rises at an angle from near the floor to the top of the filling opening so that the loose material can be conveniently placed on the low end of the conveyor belt.

Since such an automatic filling device would be in the way when emptying the box baler if the filling opening and thus also the filling device were still located on the front side of the baler, in these cases the filling opening is generally arranged in the rear side opposite the front side.

However, such a conveyor belt requires a lot of floor space in addition to the rest of the vertical box baler, whose principal advantage is precisely that it requires very little floor space, which means that its main advantage is lost. In addition, a vertical box baler equipped with it can also no longer be placed at a small distance in front of a wall.

In addition, it is often the case—particularly in the case of cardboard packaging or empty beverage containers as baled material—that the baled material is collected at a distance from the baler in open-top collector trolleys, and the filled collector trolleys are then pushed to the baler. It should then be possible to empty the collector trolley as completely as possible into the baler so that the empty collector trolley is immediately available again.

The material to be baled therefore accumulates in batches at the baler.

### III. PRESENTATION OF THE INVENTION

### a) Technical Object

It is therefore the object of the invention to provide a lifting and tilting device and a baler equipped therewith, in which the open-topped container, for example a collecting trolley, projects as little as possible upwards beyond filling opening during emptying, and which is as simple and functionally reliable as possible, as well as being inexpensive to construct and requiring as small a floor space as possible with regard to the baler.

### b) Solution of the Object

This object is solved by the features of claims 1, 11 and 26. Advantageous embodiments result from the subclaims.

With regard to the lifting and tilting device, with which a container such as, for example, a filled, at the top open, collector trolley is to be emptied into an elevated filling opening, this comprises according to the prior art, in addition to the base frame, a pivot arm which is attached to the base frame so that it can pivot about a generally horizontal arm axis and serves as a lifting device, as well as a tilting device for tilting the collection trolley. A corresponding fixing device is provided for attaching the trolley to the pivot arm or the tilting device.

According to the invention, the tilting device has a tilting part which can be tilted about a tilting axis, i.e. which can be tilted, and is attached to the pivot arm away from its arm axis, usually at the free end of the pivot arm. The fixing device for the collector trolley is also fixed, in particular fixed against rotation, to this tilting part.

In this way, the pivot arm can be made very simple and stable, since it does not need to have a joint between its arm axis and the tilting part fixed in the free end area.

The tilting device further comprises a slotted guide with which the tilting operation is performed:

The element guided in the guideway of the slotted guide, usually a guide slot, is usually a slot nut or slot roller and attached to the tilting part, away from its tilting axis.

As a result, when the pivot arm is pivoted upwards, bringing the fixing device and any collector trolley attached to it to the level of the filling opening, the tilting part and thus the collector trolley are tilted, depending on the course of the guideway, until the latter points downwards with its in the parked state upper opening and is thus emptied under the force of gravity.

The course of the guideway thus determines the point in time and the speed at which the fixing device and thus the collector trolley are tilted, so that by changing the component in which the guideway is located, it is easy to adapt it to other conditions, such as the height of the lower edge of the filling opening and the like.

Preferably, the lower part of the guideway, in particular the lower initial region of the guideway, is an arc of a circle around the arm axis, while in the upper region the guideway has a significantly greater curvature, i.e. a smaller radius of curvature, with the curvature of the guideway being greatest in its middle region. In the upper end region, on the other hand, the guideway runs almost straight and horizontally.

Preferably, the arm axis of the pivot arm and the tilting axis of the tilting part run parallel to each other, in particular horizontally. Overall, the shape of the guide groove could be described as boomerang-shaped.

Preferably, the arm axis and/or the tilting axis is perpendicular to the guide plane in which the guideway runs.

This enables a functionally reliable and simple construction of the lift-tilt device, in which the control of the lifting movement as well as the tilting movement is primarily mechanical and does not require any electronic components.

Preferably, the device comprises only one pivot arm whose pivot plane in which it is pivoted is usually only slightly spaced from the fixing device so that both can be accommodated together in one assembly.

The pivot arm can preferably be pivoted between an upper and a lower end stop, which are also part of the control system, since they limit the movement path of the pivot arm purely mechanically.

Preferably, the pivot arm points slanted downwards from the arm axis in the lower end position, i.e. in contact with the lower stop, and slanted upwards in the upper end position, i.e. in contact with the upper end stop.

Preferably, the pivot arm is pivoted with the aid of a hydraulic cylinder mounted off the arm axis as a pivot drive, the other end of which is attached to a beam-shaped bearing block projecting from the arm axis, also off the arm axis. This provides a durable and powerful swing drive at low cost.

A generic baling press for compressing, in particular, packaging materials into bales, on which such a lift-and-tilt device can be used, comprises a press box with a bottom and side walls projecting upwards therefrom, usually vertically, from its peripheral edges, which form the press box, and a press plunger which can be moved in the press box and can usually be moved with great force by means of one or more parallel-acting, usually hydraulically operated, pressing cylinders.

The cross-section of the press box perpendicular to the direction of movement of the press plunger is usually approximately rectangular, so that there are four side walls arranged in a square to each other when viewed from above, which are usually adjacent to each other, i.e. continuously surround the press box in the horizontal circumferential direction.

However, other forms of horizontal cross-sections of the press box are also possible, for example a round cross-section with the consequence that there is then a single cylindrical side wall, but this is intended to be encompassed by the mention of multiple side walls used here.

in the case of a vertically acting box baler, the press plunger moves up and down and presses against the bottom of the bale box. Often, the side walls do not always run exactly parallel to each other, but can assume a slightly increasing distance from each other from the rear to the front, towards the removal opening, in order to facilitate removal of the finished bale.

One of the side walls, referred to as the front wall, is usually embodied as a fully openable removal door for removing the finished bale, and in its upper part, in particular its upper half, there is a front filling opening which can be closed by a filling flap.

The upper edge of the filling opening is generally located below the press plunger when it is retracted into its upper end position, the starting position, even if the filling opening is located in a wall other than the front wall of the press box, which is embodied as a removal door.

If there is an automatic filling device—i.e. one that is at least motor-driven and controlled manually or by means of a control system—the filling opening is usually not located in the front wall but in one of the other side walls, usually in the rear wall opposite the front wall.

By means of such an automatic filling device, the loose material to be pressed deposited thereon or therein is not only transported to the filling opening, but also conveyed through it into the press box, and for this purpose, if necessary, pushed through the filling opening by the automatic filling device.

According to the invention, in such a baler, in particular a vertically acting box baler, the existing object is solved by the fact that it comprises a filling device with a lift-tilt device embodied as described above.

Preferably, the lift-tilt device, in particular its bearing block, is thereby bolted to the outside of the baler, which allows easy assembly and disassembly of the entire lift-tilt device and even its retrofitting.

Preferably, the lift-tilt device has only one pivot arm, and this is attached to the anti-operator side of the baler facing away from the operator side. From the pivot plane, the fixing device protrudes from the pivot arm in the direction of the operator side.

### Volume Storage Container

In particular, this automatic filling device comprises a storage container as a buffer store for receiving loose material to be pressed, the volume of which—in the case of variable volume, its maximum volume—is sufficient to receive a complete batch—the maximum volume of which is predetermined—of, in particular, loose material to be pressed. The specified batch volume is usually the volume of a collector trolley in which the loose material to be pressed is collected at the place where it is produced.

This has the advantage that the entire content of loose material to be pressed of a filled collector trolley can be emptied automatically into this automatic filling device, namely the storage container, at once and thus in a very time-saving manner.

For this purpose, the storage container preferably has a filling opening, in particular in the upper area of the storage container, so that the loose material to be pressed can fall into the storage container from above due to gravity. In particular, such a filling opening is formed in the upper side of the storage container, whereby, as the simplest solution, the upper side can be completely open as a filling opening.

It is such a large-area filling opening that makes it very easy and fast to load the storage container.

To ensure that the loose material to be pressed can be transferred as easily as possible from the storage container to the filling opening of the press box, the storage container is in communication with the filling opening or can at least be brought into communication with it.

This does not necessarily require contact between the storage container and the filling opening, but merely that the storage container and in particular its filling opening in the direction of the filling opening is or can be moved into a closely adjacent position to the filling opening.

The bottom of the storage container is at the level of the lower edge of the filling opening or slightly above it and extends close to it to at least 2 cm or at least 1 cm or even into the filling opening.

This allows the material to be pressed to be pushed along the bottom of the storage container into the filling opening.

### Lift and Tilt Device

The lift and tilt device is embodied so that the collector trolley is lifted upwards only as little as necessary for emptying, even though it protrudes far upwards due to tilting over the filling opening, and often only a limited free height is available at the place of use of this baler.

Manually, the filled collector trolley only has to be brought into contact with the fixing device of the lift-tilt device, and if this does not cause automatic latching, it has to be fixed to it manually.

Preferably, a sensor monitors whether a collector trolley is present and/or correctly attached to the fixing device and thus to the tilting device.

### Storage Slide

In order to transport the material to be pressed from the storage container into the filling opening of the box press, the storage container preferably has a driven storage slide which can be moved towards and away from the filling opening between two end positions so that this also does not have to be carried out manually.

In one end position, the storage slide closes the filling opening of the press box and its front surface is then part of the inner surface of the press box and/or the storage slide is part of the side wall in which the filling opening is located. This keeps the number of components and the weight of the baler low.

In the other end position, the storage slide is located at the end of the storage container facing away from the filling opening, so that loose material to be pressed can be filled in between.

The storage slide can either be moved back and forth in the storage container or the end wall of the storage container facing away from the filling opening is itself the storage slide and can move in the transverse direction to the filling opening. This keeps the number of components low.

Preferably, the side walls are then embodied to be variable in length, in particular embodied in several parts, in particular embodied to be telescopic, but they can also be rigid, one-piece side walls, which then still project far from the rear of the actual baler when the end wall is moved in the direction of the filling opening.

The storage slide is usually moved by means of slide cylinders on both sides, preferably running in its direction of movement, or by another slide drive.

A particularly space-saving arrangement results when these slide cylinders run along the outer sides of the storage container and, in particular, also along the outer sides of the transverse walls of the press box, since they then generally do not project further than the storage container itself in any of their possible positions.

They are preferably embodied as pull cylinders, i.e. they can be pressurized in particular in the direction in which the piston enters the cylinder.

### Cover Flap

In order to prevent the loose material to be pressed from piling up over the upper filling opening of the storage container when the loose material to be pressed is pushed forward in the storage container in the direction of the filling opening, the storage container has a cover flap, which is displaceable, in particular pivotable, between a closed position closing the filling opening or, in particular, the entire open upper side of the storage container and an open position not closing the latter, in particular leaving it completely open, so that in this open position the filling opening is available for the filling of loose pressed material.

In the dosed position, the bottom of the cover flap should be parallel to the bottom of the storage container to create a channel that is consistent in height and that the storage container slide substantially fills in height in each of its functional positions.

At its free end, i.e. the end facing away from its pivot axis, the cover flap can also have an offset or other retaining elements which are directed towards the inside of the storage container in order to prevent material to be pressed from being pushed out over the rear edge of the storage container when the cover flap is lowered.

The storage slide should of course fill the channel created by the dosed supply container in the direction of the filling opening as far as possible, also in terms of width, in each of its functional positions.

### Guide Flap

Alternatively, the storage container can comprise a guide flap, the underside of which serves as a guide surface for the loose material to be pressed towards the filling opening.

For this purpose, it can be moved, in particular pivoted, between a guide position at an angle to the bottom above the filling opening of the storage container, in which the underside of the guide flap approaches the base of the storage container in the direction of the filling opening, and an open position which does not overlap the latter.

As a result, the top edge of the storage slide does not rest against or reach close to the underside of the flap, but no significant force needs to be applied to press down the flap as with a cover flap. Instead, the storage slide pushes the loose material to be pressed along the bottom in the direction of the filling opening, whereby the material to be pressed can pile up over the upper edge of the storage slide, limited only by the underside of the guide flap.

By retracting and advancing the storage slide again, a considerable amount of loose material to be pressed can still be fed into the press box in several strokes.

It is advisable to provide a cover element extending from the upper edge of the storage slide in the direction away from the filling opening in order to prevent material to be pressed from falling behind the storage slide, i.e. on the side facing away from the filling opening.

At least in the guide position, there are then preferably side plates which, in the guide position, close the free space between the side edges of the guide flap and the edge of the filling opening of the storage container in order to prevent the material to be pressed from escaping or projecting sideways.

Slant Drive

In order to keep the overall height of the filling device as low as possible and to position its filling opening as low as possible for this purpose, the bottom of the storage container can be embodied slanted upwards, at least from the end of the base area located below the filling opening, preferably over its entire length.

Nevertheless, the bottom is preferably embodied as a flat surface and rises towards the filling opening, in particular towards its lower edge, so that the storage slide can be moved along the base in a linear sliding movement and can always maintain the same small distance from the base or even touch the base. For this purpose, the sliding direction of the storage slide runs parallel to the bottom of the supply container.

Nevertheless, in this case the front side of the storage slide is preferably arranged parallel to the inner surface of that side wall in which the filling opening is located, so that the storage slide in its end position, in which it is located in the filling opening, is part of the corresponding side wall of the press box and its inner surface can be aligned with the inner surface of the corresponding side wall.

### Storage Container Can Be Lifted

Alternatively, the storage container can be attached to the press box so as to be displaceable in height and can be raised to an upper position in which the edge of the bottom on the press box side is aligned with the lower edge of the filling opening in a side wall, in particular the rear wall, of the press box or lies somewhat higher.

When the collector trolley is tilted in, the storage container is then in a lowered position just above the ground so that the collector trolley, which is almost upside down, does not rise very far when it is emptied into the storage container.

### Separate Drives

Frequently, not only the at least one press plunger, but also the moving parts of the automatic filling device, i.e. in particular the storage slide and/or the cover flap and/or the tilting device or lift-tilt device and/or, if applicable, the liftable bottom and/or the overall liftable storage container, are actuated by means of working cylinders, in particular hydraulic cylinders.

The working cylinders of the automatic filling device, in particular its slide cylinders, can be operated with the same working medium as the press cylinder(s) actuating the press plunger with at least one press plunger, and can also be supplied with pressure medium from the same pressure medium source.

Preferably, however, the filling device and the press plunger are to be operable independently of each other, in particular partially overlapping in time, and for this purpose there are preferably two separate and/or separately controllable drives for the at least one press plunger on the one hand and at least one or some movable parts of the filling device on the other hand, in particular two independently controllable hydraulic pumps

With regard to the operating method for operating a baler, in particular a vertically acting box baler, as described above, this object is solved in that the automatic filling of the baler or its press box, which is known per se, is carried out in batches.

This means that when batches of loose material to be pressed accumulate, work can be carried out with very little manpower, as the loose material to be pressed is automatically pressed, in particular pushed, through the filling opening into the press box until the entire batch of material to be pressed is inside the press box.

### By Means of Cover Flap or Guide Flap

Preferably, before or during pushing into the press box, the loose material to be pressed is compacted in height to a height equal to or less than the height of the filling opening of the press box.

This means that the precompacted material to be pressed can be moved, for example pushed, through the filling opening into the press box without further measures.

### Keep Width

For the same reason, it is preferred that the loose material to be pressed is either distributed over an equal or smaller width on the bottom of the storage container than the width of the filling opening before being pressed into the press box or is compressed in width to such a width, which is smaller than the width of the filling opening, before or during pushing into the press box.

### Filling During Pressing

In order to increase the throughput of the baler, the next filling is preferably already prepared while the material is being pressed in the press box. For this purpose, preferably at least the emptied collector trolley is moved back from the tilting device into the docking position in which it stands on the floor and can be detached from the fixing device and thus from the tilting device, in particular a new, filled collector trolley can already be fastened to the tilting device.

While the bale is being pressed, the storage container of the filling device can also be refilled, if necessary, because the storage slide can already be moved back from its front end position, in which it is part of a side wall of the press box, as soon as the press plunger has passed the filling opening and continues to move forward downward, and even more so while it subsequently moves back to its upper starting position.

If necessary, the storage container can even be refilled when the storage slide has not yet reached its initial position furthest away from the filling opening of the press box, in which case, however, the space on the side facing away from the front surface of the storage slide, which is part of the side wall of the press box during pressing, must be covered at the top in order to prevent material to be pressed from falling into this area.

### Slant Drive

In order to be able to fill the storage container at the lowest possible level, the loose material to be pressed is pushed upwards to the level of the filling opening before being pushed into the press box.

Lift Storage Container

Alternatively, the material to be pressed can be lifted up to the height of the filling opening before being pushed into the press box, in particular together with the storage container in which it is located.

### EXAMPLES OF EMBODIMENTS

Embodiments according to the invention are described in more detail below by way of example. They show:

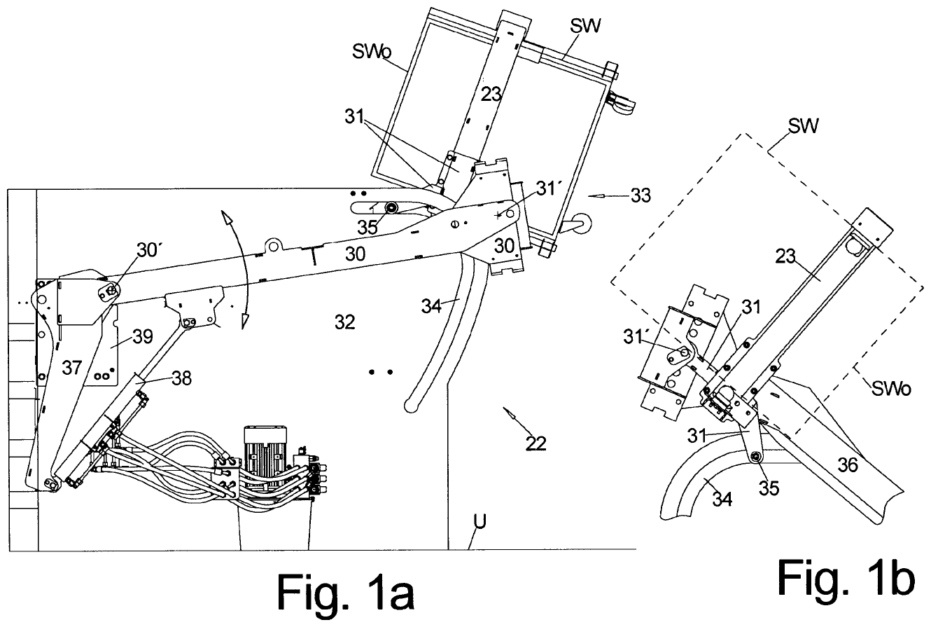

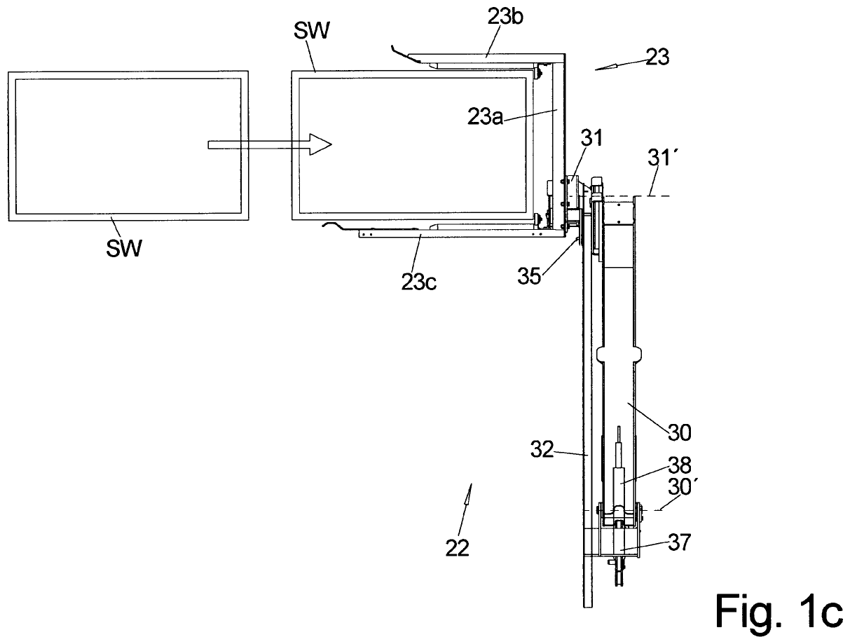

FIG. 1a: the lift-tilt device as a separate assembly in side view, with the pivot arm approximately in the upper end position,

FIG. 1b: the tilting device in enlarged detail, with the viewing direction opposite to the viewing direction of FIG. 1a, even closer to the upper end position than in FIG. 1a,

FIG. 1c: the tilting device of FIGS. 1a, b in top view, with the pivot arm in the lower end position during insertion of a collection trolley,

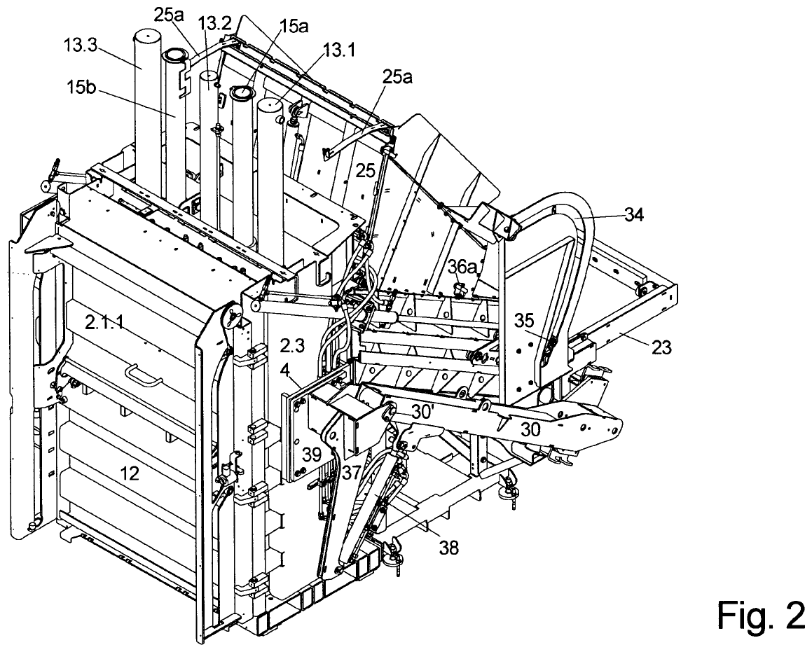

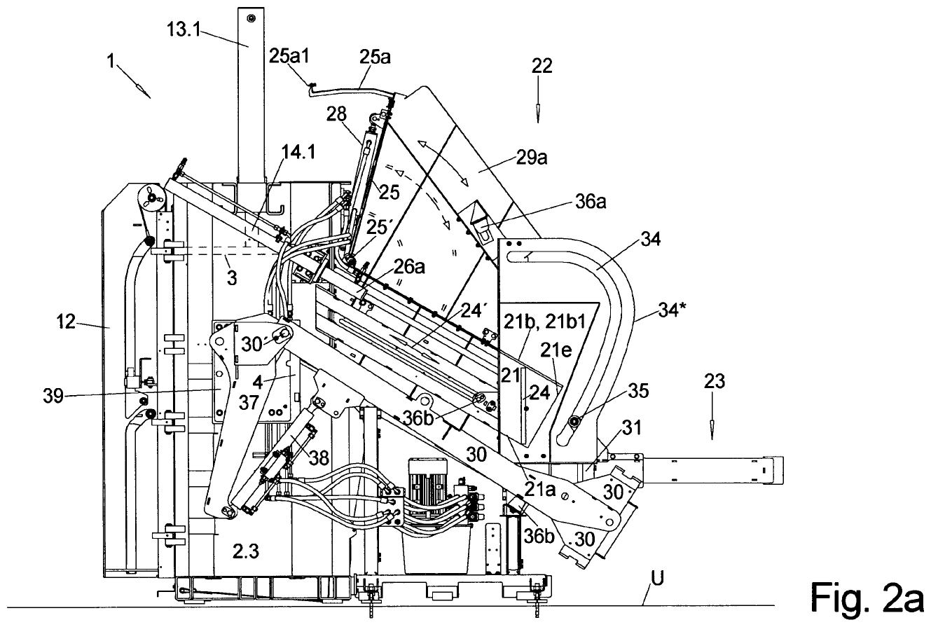

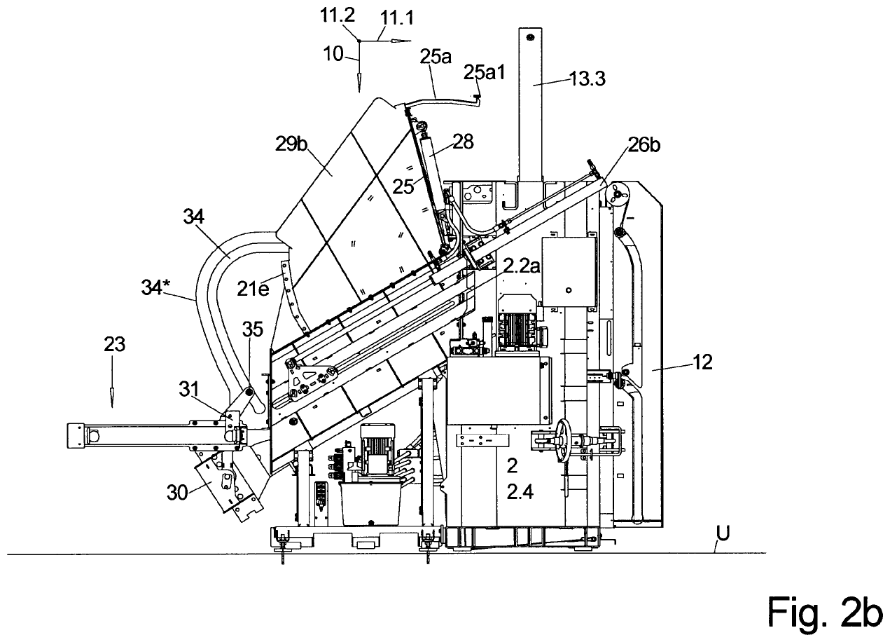

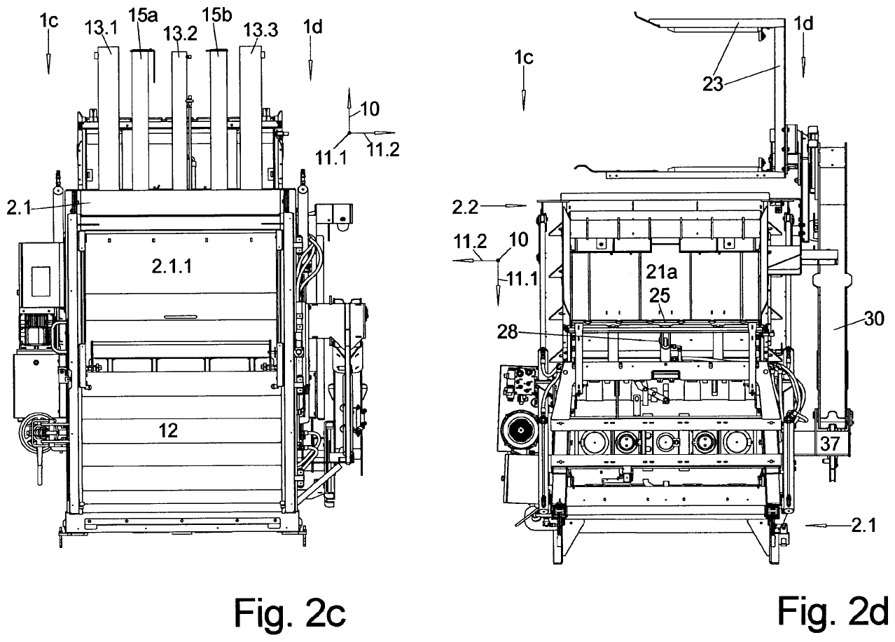

FIG. 2: a first embodiment of a baler according to the invention with integrated lift-tilt device in perspective view,

FIG. 2a: the baler of FIG. 2 in side view, with the pivot arm approximately in the lower end position,

FIG. 2b: the baler in the position according to FIG. 2a in another side view with the viewing direction opposite to FIG. 2a,

FIG. 2c: the baler according to FIG. 2 in front view, i.e. looking at the removal door,

FIG. 2d: the baler according to FIG. 2 in top view with flap of the storage container open,

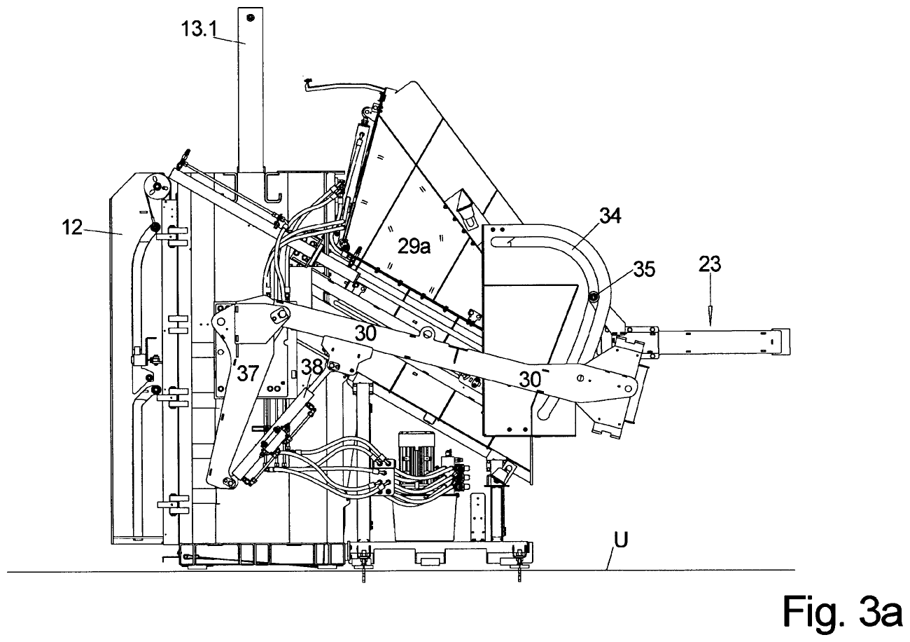

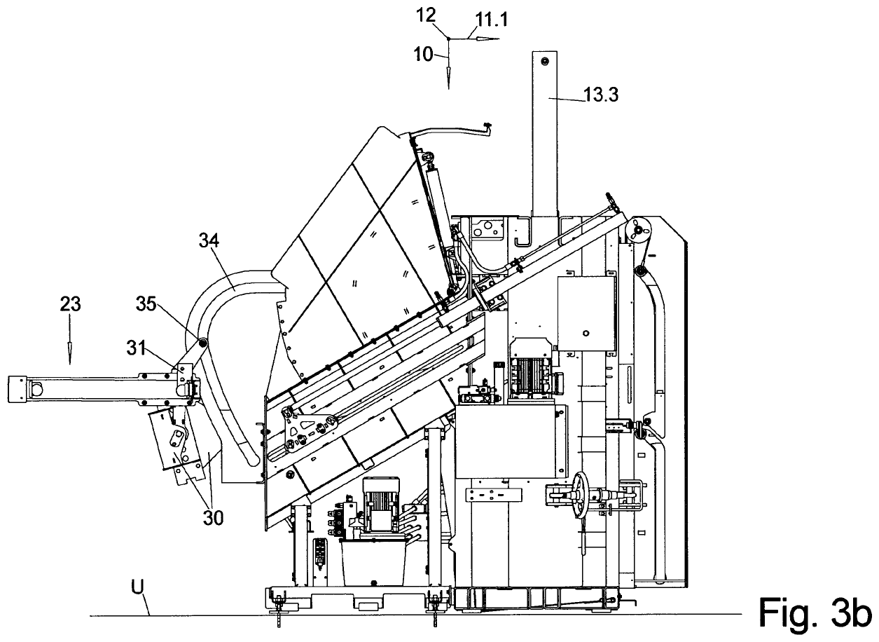

FIG. 3a: the baler of FIG. 2 in side view, with the pivot arm in a central pivot position,

FIG. 3b: the baler in the position according to FIG. 3a in another side view with the viewing direction opposite to FIG. 3a,

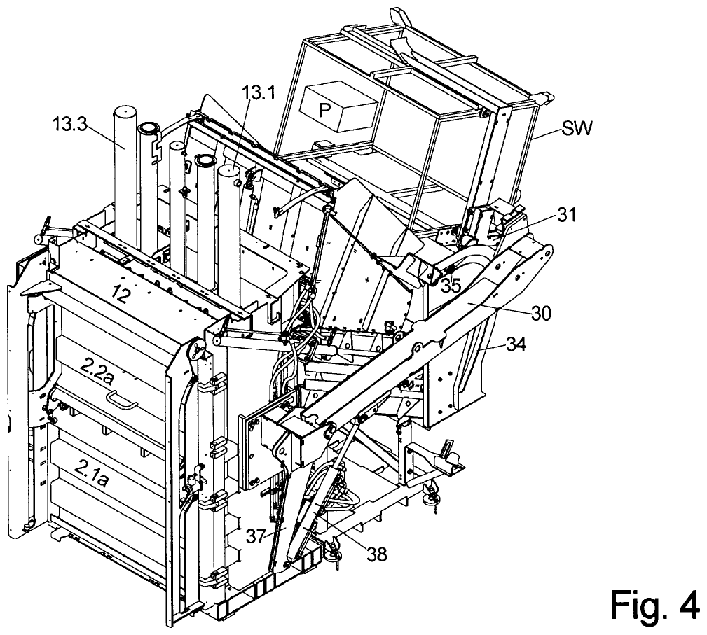

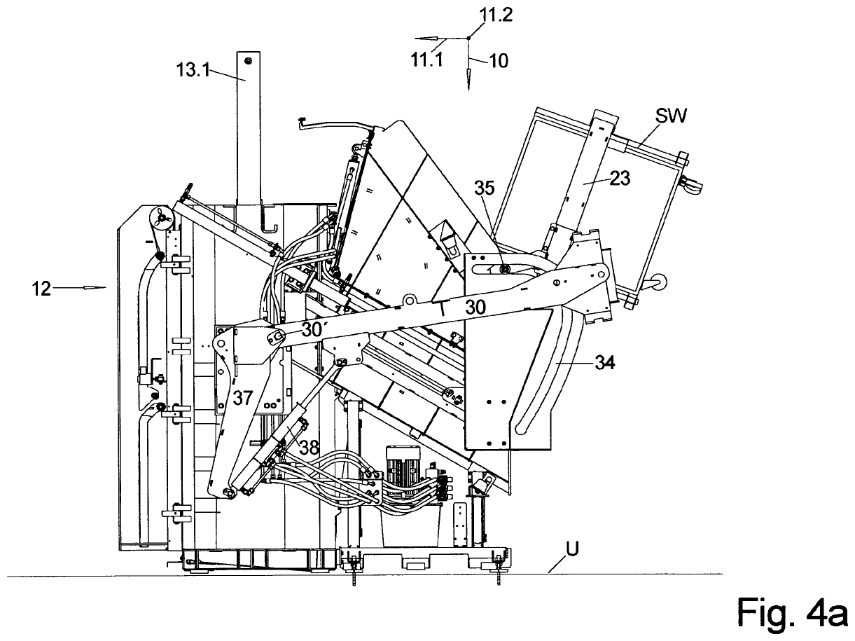

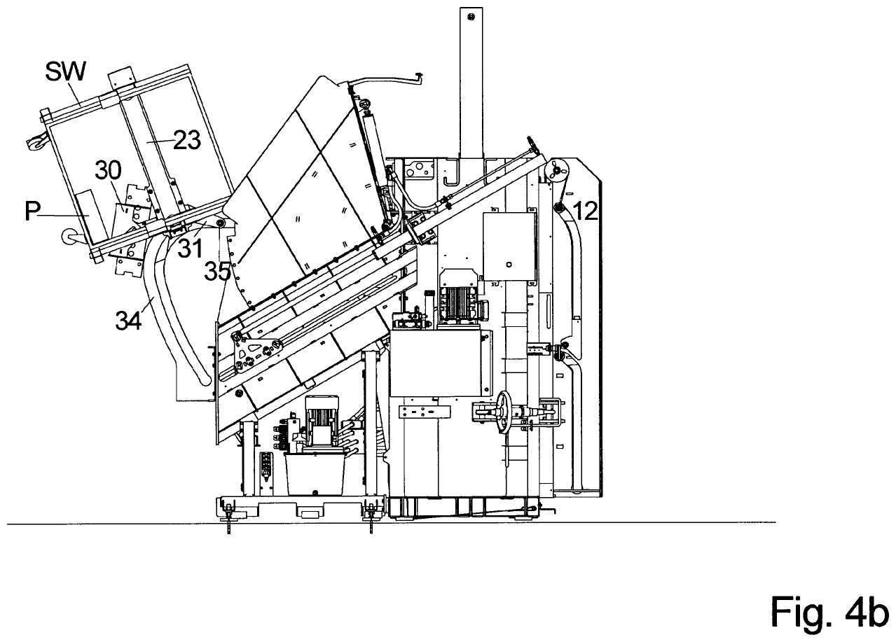

FIG. 4: a perspective view of the baler according to the previous figures, with the pivot arm approximately in the upper end position and a collector trolley suspended in the lift-tilt device,

FIG. 4a: a side view of the baler in the functional position according to FIG. 4

FIG. 4b: the baler in the position according to FIG. 4a in another side view with the viewing direction opposite to FIG. 4a,

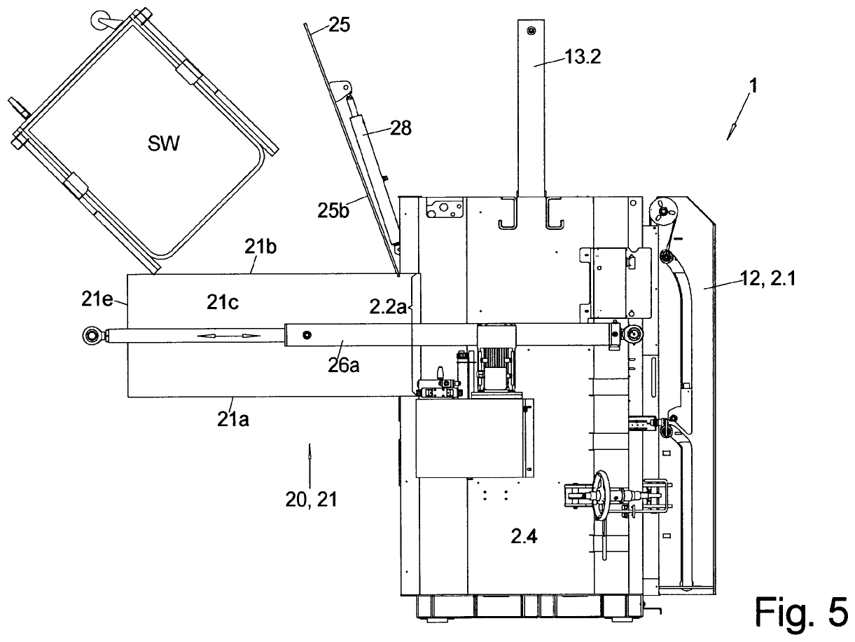

FIG. 5: A second design of a box baler in side view, in which the lift-tilt device can be integrated or installed on it.

FIGS. 1a-c show the lift-tilt device 22 including the tilting device 33 in side view, i.e. looking in the direction of the arm axis 30′ about which the pivot arm 30 pivots, as a separate assembly.

In FIG. 1a, the pivot arm 30 points upward at an angle from its arm axis 30′ and is near its upper end position, and the slot roller 35 is already in the upper part of the guide groove 34.

Accordingly, the collector trolley SW attached to a fixing device 23, which is held on the pivot arm 30 by means of a tilting part 31, is already raised far from the floor U on which it is approached for hooking into the lowered fixing device 23 as shown in FIG. 1c.

In this case, the upper opening SWo of the collector trolley SW already points to the left and hardly upwards, as in the initial state of the collector trolley SW standing on the floor U.

It is conceivable from FIG. 1a that by only slightly pivoting the pivot arm 30 further upwards, the tilting part 31 moves further upwards and thus, in FIG. 1a, the slot roller 35 in the guide groove 34 moves away from the upper end of the guide groove 34 again, i.e. backwards, due to the almost horizontal course in this area, and in the process the tilting part 31 is tilted further until the upper opening SWo of the collector trolley SW points with its filling opening downwards and thus its contents fall out downwards.

Exactly this further raised position of the pivot arm 30 and even more tilted position of the tilting part 31 is shown in FIG. 1b, but in the opposite viewing direction to FIG. 1a.

The tilting axis 31′ is located in the pivot arm 30 outside the guide groove 34 as viewed from its arm axis 30″, which runs approximately horizontally in this upper end region.

As can best be seen in FIG. 1c, the guide groove 34 is incorporated in a base frame 32 in the form of a base plate 32.

The pivot arm 30—on which the fixing device 23 is cantilevered mounted, i.e., mounted on only a single pivot arm 30—is supported in a solidly formed, armshaped bearing block 37, which is attached to one side, the arm side, of the base plate 32 via a reinforcing flange plate 39.

The tilting part 31, on the other hand, is located on the other side, the carriage side, of the base plate 32, and the tilting axis 31′, via which the tilting part 31 and the pivot arm 30 are hinged to one another, is located outside the base plate 32 in the view of the base plate 32 according to FIG. 1a, which is why the pivot arm 30 also extends beyond the end of the base plate 32 remote from its arm axis 30′.

Accordingly, the fixing device 23 is also located on the carriage side of the base plate 32, and in FIG. 1c—in which the pivot arm 30 is near or in its lower end position—it can be seen that this has a U-shaped fork, the opening of which points perpendicularly away from the base plate 32, and between the two free-ending legs 23b, c of which a collector trolley SW can be retracted while moving on the base U the two free-ending legs 23b, c up to near or at the connecting leg 23a of the fixing device 23, where it can be locked relative to the fixing device 23, in particular by latching.

To pivot the pivot arm 30, a hydraulic cylinder 38, which is inserted away from the arm axis 30″ between the bearing block 37 and the pivot arm 30, is extended or retracted. The hydraulic cylinder 38 is supplied with hydraulic fluid by its own hydraulic pump driven by an electric motor, which is also attached to the base plate 32 on the arm side, or from a hydraulic source remote therefrom, and can be acted upon in either the extending direction or the retracting direction.

Thus, the lift-and-tilt device 22 may be positioned adjacent to an assembly having a filling opening into which a collector trolley SW is to be emptied.

FIGS. 2 to 4b show the lift-tilt device 22 integrated in or installed on a first embodiment of a box baler 1, whereby the base plate 32 of the separate lift-tilt device 22 serving as a fastening base in FIGS. 1a-c is in this case—see best FIGS. 2 and 2a—divided into a flange plate 39, which supports the bearing block 37 and is bolted to a counter-flange plate 4, which is part of the rest of the box baler 1, and a guide plate 34*, in which the guide groove 34 is incorporated, and which is also bolted to the rest of the box baler 1.

Preferably, the hydraulic circuit of the baler 1 is connected to and supplied with hydraulic fluid from the hydraulic cylinder 38 of the lift-tilt device 22, rather than using its own hydraulic pump.

In FIGS. 2, 3 and 4, the pivot arm 30 is in a different functional position in each case, and only in FIGS. 4a, b is a collector trolley SW shown in the fixing device 23 in this case.

It can be seen that the arm axis 30′ lies in the width range of the press box 2 in the direction of view of the arm axis 30′.

The vertically acting box baler 1 shown comprises, as generic components, a press box 2 with a bottom 2a which, viewed in plan view, has an approximately rectangular shape in this case, so that a total of four side walls 2.1 to 2.4 project upwards from its outer regions, namely a front wall 2.1, a rear wall 2.2 opposite the latter, and longitudinal walls 2.3, 2.4 connecting these two walls to one another.

In the press box 2, as can best be seen in FIGS. 2a, a press plunger 3 in the form of a plate lying horizontally and thus parallel to the bottom 2a of the press box 2 can be moved up and down in the vertical, the pressing direction 10, which can press the material to be pressed M lying in the press box 2 on the bottom 2a.

The press plunger 3 is attached to the lower ends of the piston rods—only piston rod 14.1 is visible in FIG. 2a, while 14.2 and 14.3 are behind it in the direction of view—by a number of press cylinders 13.1 to 13.3 which are spaced apart vertically in the second horizontal transverse direction 11.2, stand next to each other and project beyond the upper end of the press box 2 and are embodied as hydraulic cylinders.

To apply high pressing forces, the two outer pressing cylinders 13.1 and 13,3 are extended downward, while the middle pressing cylinder 13.2 with its smaller cross section is used as a rapid-motion cylinder, for example to move the pressing press plunger 3 quickly upward back into the deactivated position.

Between the vertically extending press cylinders 13.1 to 13.3, which are arranged in a common plane parallel to one another, there is in each case a guiding rod 16a, b, the lower ends of which are likewise firmly connected to the press plunger 3 and are intended to prevent an inclined position and thus tilting of the press plunger 3 in the press box 2.

The front wall 2.1 of the press box 2, which is present on the front side 1a of the box baler 1, is hinged to one of the longitudinal walls 2.3 via a vertically positioned pivot axis and can be swung open relative to the latter like a door—as shown closed in FIG. 2b, c—for the removal of a finished bale.

In a vertical box baler of this type, the rear wall 2.2 of the pressing box 2 is usually closed or at most—if strapping of the finished bales is provided—has slots for the strapping medium to pass through.

The rear wall 2.2 representing the rear side 1b is preferably manufactured as a one-piece welded part, and the filling of the press box 2 with material M to be pressed is carried out from the front side 1a, in that in the movable front wall 2.1, which thereby forms a removal door 12, the upper part is formed as a filling flap 2.1.1, which is movably attached to the rest of the front door 2.1 and can be moved downward along guides so that a filling opening is open in the upper part of the front wall 2.1, via which material to be pressed can be inserted from the front side 1a.

On the one hand, the operator side 1c, on which the operating elements such as input unit, emergency switch and the like for the operator are arranged, runs between the front side 1a and the rear side 1b. The pivot arm 30 of the lift-tilt device 22, on the other hand, is arranged on the anti-operator side 1d opposite the operator side 1c. The fixing device 23, which is U-shaped in plan view, for holding the collector trolley SW projects in front of the front side 1a.

On the one hand, the vertically acting box baler 1 shown, additionally has a filling opening 2.2a in the upper region of the rear wall 2.2, which represents the rear side 1b, through which it can be filled automatically.

The filling opening to be opened in the front wall 2.1, formed as described by forming a filling flap 2.1.1 in the removal door 2.1, may additionally be present, but this is not a prerequisite for the realization of the invention. The front wall 2.1 can be formed as a closed removal door 12, which is only movable as a whole as a door.

Automatic filling is carried out by means of a filling device 20, which additionally comprises a box-shaped storage container 21, which adjoins the rear wall 2.2 of the press box 2 on the outside and has a bottom 21a sloping downwards from the press box 2 in FIGS. 2-4, from which side walls 21c, d and, at the free end, an end wall 21e project, the side walls extending as far as the filling opening 2.2a in the rear of the press box 2.

The upper side 21b of the storage container 21 can be closed by a cover flap 25, which can be pivoted about a horizontally extending pivot axis 25′ near the press box 2 between the lowered position of the cover flap 25 closing the upper side 21b, in which the lower side of the cover flap 25 runs parallel to the bottom 21a of the storage container 21, and a filling position in which the cover flap 25 is pivoted upwards—as shown—with the aid of a tilting cylinder 28.

In this filling position, a collector trolley SW filled with material to be pressed M and open at the top SWo can be swung up and emptied into the storage container 21 over the top edge of the end wall 21e of the latter.

Lifting, tilting, emptying, tilting back and setting down of the collector trolley SW is generally performed automatically by means of the lifting-tilting device 22 according to the invention, as shown in FIGS. 2-4 and described previously with reference to FIGS. 1a to 1c.

After the collector trolley SW has been swung back, the cover flap 25 can be closed by means of the tilting cylinder 28, the tilting cylinder 28 being able to provide sufficient pivot force to ensure that loose material M to be pressed projecting above the level of the upper edge of the end wall 21e from the underside 25b of the cover flap 25 is compressed below this level.

Since only one tilting cylinder 28 is to be used, which is centered on the cover flap 25 in the 2nd transverse direction 11.2, it must be avoided that when the cover flap 25 is pressed down into the upper side of the storage container 21 by material M of different rigidity on the two sides, the cover flap 25 does not quite reach the upper side of the storage container 21 at its free end on one side and lies somewhat filling opening and thus the other side lies too low, namely in the path of movement of the slide 24 and blocks it.

For this purpose, at the two lateral ends of the cover flap 25 in the 2nd transverse direction 11.2, the stop arms 25a, which are best visible in FIGS. 2 and 2b, are arranged at the free end edge of the cover flap 25 and project backwards from it, i.e. in the direction facing away from the storage container 21.

At their free ends, they each have a stop hook 25a1 which, when the cover flap 25 is closed, strikes the upper end edge of the rear wall 21e of the storage container 21 and prevents the free end of the cover flap 25 from sinking too deeply into the storage container 21

Inside the storage container 21, a storage slide 24 is movable between a retracted position near the end wall 21e and an advanced or advanced position near the filling opening 2.2a of the press box 2, the lower edge of the storage slide 24 moving along close to the bottom 21a.

In the advanced end position, the storage slide 24 is preferably not only close to the filling opening 2.2a, but in this filling opening 2.2a, which it closes completely, so that it becomes part of the rear wall 2.2 of the press box 2 and its front surface facing the press box 2 is aligned with the inner surface of the remaining rear wall 2.2.

The storage slide 24 is moved by means of two slide cylinders 26a, b which run along the outer sides of the side walls 21c, d of the supply container 21 and also along the longitudinal walls 2.3, 2.4 of the press box 2 in the first horizontal transverse direction 11.1, one end of each slide cylinder 26a, b being fixed to a respective one of the longitudinal walls 2.3, 2.4 in the vicinity of the front wall 2.1, while the other end is connected to the storage slide 24 through the side wall 21c, d of the storage container 21.

The slide cylinders 26a, b are preferably embodied as double-acting hydraulic cylinders that can be pressurized in both directions.

In the embodiment of FIGS. 2 to 4, the bottom 21a of the storage container 21 rises filling opening towards the rear filling opening 2.2a in the rear wall 2.2 of the press box 2, and the plate-shaped storage slide 24 is vertical, completely filling the cross-section of the storage container 21, i.e. transversely to the direction of extension of the slide cylinders 26a, b, the slide direction 24! of the storage slide 24, so that no material M to be pressed can get between them.

As a result, its free end facing away from the bale chamber 2, i.e. also the end wall 21e and its upper edge, is considerably lower than in the second design according to the following FIG. 5, so that the collector trolley SW does not have to be lifted as far above this upper edge for emptying and thus in its emptying position—also shown in FIG. 3a—also projects less far upwards, in fact hardly above the height level of the upper end of the rest of the baler, in particular the upper ends of the baling cylinders 13.1-13.3.

FIG. 5 shows this second embodiment of a box baler 1, in which the lift-tilt device 22 could be integrated or installed on it, in which the essential difference compared to the first design of FIGS. 2 to 4 is that the bottom 21a of the storage container 21 runs horizontally.

Additionally, in FIG. 5, the cover flap 25 is shown swung up and open with its bottom 25b facing downward at an angle, as is necessary to allow goods M to fall from a storage container SW into the storage container 21.

The end wall 21e of the storage container 21 is vertical as in the 1st embodiment, and so is the storage slide 24 arranged therein, but the slide direction 24′ of the storage slide 24 is now horizontal.

The remaining construction of the baler 1 corresponds to that of the first embodiment of FIGS. 2 to 4.

Furthermore, in FIGS. 2a to 4a, the optional side plates 29a, b, which are best seen in FIG. 2a, are present in alignment with or parallel to the side walls 21c, d of the storage container 21 and extend them upwardly, thereby increasing the filling volume of the storage container 21. The cover flap 25 pivots downward between the side panels 29a, b to the lower end position.

When used as a cover flap 25, this lower end position is an end position parallel to the base 21a, in which the distance between the closed cover flap 25 and the base 21a then remains the same over the entire displacement path of the storage slide 24, in particular until the latter has reached its end position in the filling opening 2.2a and there becomes part of the corresponding side wall 2.2.

Of course, the lift-and-tilt device 22 according to the invention can also be used to empty the contents of a collector trolley SW directly into a pressing box 2, and not only into a storage container 21 upstream of this press box 2 and serving as a buffer store.

As shown, this can be a box baler, in particular a vertically acting box baler, or also a—then usually horizontally acting—channel baler.

### REFERENCE LIST

1 baler, box baler

1a front side

1b back side

1c operator side

1d anti operator side

2 press box

2a bottom

2.1 sidewall, front wall

2.1.1 filling flap

2.1a removal opening

2.2 sidewall, back wall

2.2a filling opening

2.3, 2.4 side wall, longitudinal wall

3 press plunger

4 counter flange plate

10 Pressing direction, vertical

11.1 1. transversal direction, process flow direction

11. 22. transversal direction

12 removal door

13.1-13.3 press cylinder

14.1-14.2 piston rod

15a,b guiding rod

20 filling device

21 storage container

21a bottom

21b top side

21b1 batch opening, charge opening

21c,d sidewall

21e end wall

22 Lift and tilt device

23 fixing device

24 storage slid

24′ direction of movement, sliding direction

25 cover flap

25′ tilting axis

25* guide flap

25a stop arm

25a1 stop hook

25b underside

26a, b slide cylinder

27 cover element

28 tilting cylinder

29a, b side plate

30 pivot arm

30′ arm axis

31 tilting part

31′ tilting axis

32 base press plunger, base plate

33 tilting device

34 guideway, guide groove

34* guide plate

35 guided element, slot nut, slot roller

36a, b upper/lower end stop

37 bearing block

38 hydraulic cylinder

39 flange plate

P material to be pressed

SW collector trolley

SWo upper opening

U floor

1. Lift-tilt device (22) for picking up, moving and emptying a collector trolley (SW) filled with packaging materials, comprising
a base press plunger (32),
a pivot arm (30) that is pivotally attached to the base press plunger e (32) about an arm axis (30′),
a fixing device (23) for fastening the collector trolley (SW) to the pivot arm (30),
a tilting device (33) for tilting the collector trolley (SW),
characterized in that
the tilting device (33) comprises a tilting part (31) pivotably mounted on the pivot arm (30) about a tilting axis (31′), wherein
the fixing device (23) is fixed against rotation to the tilting part (31).

2. Lift-tilt device according to claim 1,
characterized in that
the tilting device (33) is a slotted guide (33) with a guideway (34) and a guided element (35) guided along the latter,
the tilting part (31) carries the guided element (35).

3. The lift-tilt device according to claim 2,
characterized in that
the guideway (34) is a guide groove (34),
the guided element (35) is a slot nut (35), in particular a slot roller (35).

4. The lift-tilt device according to claim 1,
characterized in that
the pivot arm (30) is rigidly formed between the arm axis (30′) and the tilting part (31), in particular does not comprise a joint.

5. The lift-tilt device according to claim 1,
characterized in that
the arm axis (30′) and the tilting axis (31′) are parallel to each other,
in particular are horizontally.

6. The lift-tilt device according to claim 1
characterized in that
the device comprises only one pivot arm (30).

7. The lift-tilt device according to claim 1,
characterized in that
the pivot arm (30) can be pivoted between an upper and a lower end stop (36a, b),
in particular the pivot arm (30) points inclined downwards from the arm axis (30′) in the lower end position, i.e. in contact with the lower end stop (36a), and points inclined upwards in the upper end position, i.e. in contact with the upper end stop (36b).

8. The lift-tilt device according to claim 7,
characterized in that
the pivot drive for the pivot arm (30) is a hydraulic cylinder (38).

9. The lift-tilt device according to claim 2,
characterized in that
the lower part of the guideway (34), in particular the lower initial area of the guideway (34), is an arc of a circle around the arm axis (30′) and/or
the curvature of the guideway (34) is greatest in its central region.

10. The lift-tilt device according to claim 8,
characterized in that
the lift-tilt device (22) comprises a bearing block (37) in which the pivot arm (30) is pivotably mounted and
the hydraulic cylinder (38) for pivoting the pivot arm (30) is fixed between the bearing block (37) and the pivot arm (30).

11. Baler (1) for compressing in particular packaging materials into bales, comprising
a press box (2) with a bottom (2a) and side walls (2.1-2.4) projecting upwardly therefrom and a removal opening,
a press plunger (3) movable in the press box (2),
a filling device (20) with a lift-tilt device (22) for picking up, moving and emptying a collector trolley (SW) filled with packaging materials for automatic filling of the press box (2) through a filling opening (2.2a),
characterized in that
the lift-tilt device (22) is embodied according to claim 1.

12. A baler according to claim 11,
characterized in that
the lifting-tilting device (22) is attached to the baler (1) in particular as a base fpress plunger e (32),
in particular the bearing block (37) is bolted to the baler (1).

13. The baler according to claim 11,
characterized in that
the baler (1) is a vertical box baler (1),
the press plunger (3) can be moved up and down in the press box (2).
the press box (2) has a removal opening (2.1a) which can be closed by a removal door (12).

14. The baler according to claim 11,
characterized in that
if only one pivot arm (30) is present, this is attached to the baler (1) on the anti-operator side (1d) facing away from the operator side (1c),
the fixing device (23) extends from the pivot arm (30) in the direction to the operator side (1c).

15. The baler according to claim 11,
characterized in that
the filling device (20) comprises a storage container (21) for receiving loose material to be pressed (P), which comprises a filling opening (21b1), in particular in the upper region, in particular in the upper side (21b), of the storage container (21), in particular in that the upper side (21b) is completely open,
the storage container (21) is in communication with the filling opening (2.2a), in particular the bottom (21a) of the storage container (21) extends up to the filling opening (2.2a) and ends at its level or above it, in particular adjoins it.

16. The baler according to claim 11,
characterized in that
the storage container (21) has a sufficiently large volume to hold a complete batch with, in particular, a predetermined volume of, in particular, loose material to be pressed (P),
the specified volume of a complete batch corresponds to the volume of a collector trolley (SW) for loose material to be pressed (P).

17. The baler according to claim 11,
characterized in that
the storage container (21) comprises a storage slide (24) which is movable towards and away from the filling opening (2.2a) between two end positions,
wherein
in one end position the storage slide (24) closes the filling opening (2.2a) of the press box (2) and its front surface is part of the inner surface of one of the walls (2.2-2.4) of the press box (2) and/or in one end position the storage slide (24) is part of that side wall (2.2) in which the filling opening (2.2a) is located,
in particular in the other end position, the storage slide (24) is located at the end of the storage container (21) facing away from the filling opening (2.2a).

18. The baler according to claim 17,
characterized in that
the storage slider (24)
either can be moved back and forth in the storage container (21),
or the end wall (21.1) of the storage container (21) facing away from the filling opening (2.2a) is the storage slide (24) and in particular the side walls (21.2, 21.3) are embodied to be variable in length, in particular multi-part, in particular telescopic.

19. The baler according to claim 17,
characterized in that
the storage slide (24) is moved by means of slide cylinders (26a, b) on both sides, preferably running in its direction of movement (24′),
which run in particular along the outer sides of the storage container (21)
and in particular also along the outer sides of the longitudinal walls (2.3, 2.4) of the press box (2),
and/or
the slide cylinders (26a, b) are embodied as pull cylinders.

20. The baler according to claim 17,
characterized in that
the pivot arm (30), the storage slide (24), and the at least one press plunger (3) have separate drives and in particular can be actuated independently of one another,
in particular in the case of hydraulic drives, separate and in particular independently controllable pressure sources, in particular hydraulic pumps, are provided for this purpose.

21. The baler according to claim 11,
characterized in that
the storage container (21) comprises a cover flap (25) which is displaceable, in particular pivotable, between a closed position closing the filling opening (21b1), in particular the open upper side (21b), of the storage container (21) and an open position not closing it, in particular leaving it completely open,
in particular the volume of the storage container (21) in the closed position of the cover flap (25) is less than the predetermined volume of a batch, in particular in the closed position, the underside (25b) of the cover flap (25) runs parallel to the bottom (21a) of the storage container (21),
and/or
the cover flap (25) has, on its free side facing away from its pivot axis (25′), an offset in the direction of the storage container (21).

22. The baler according to claim 21,
characterized in that
the cover flap (25) is embodied in such a way that it can be used as a guiding flap which can be displaced, in particular pivoted, between a guide position inclined to the bottom (21a) above the open top (21b) of the storage container (21) and an open position less overlapping the latter,
in the guide position, the underside of the guiding flap approaches the bottom (21a) of the storage container (21) in the direction of the filling opening (2.2a),
in particular, side plates (29a, b) are provided which, in the guide position, close the free space between the side edges of the guiding flap and the edge of the open top (21b) of the storage container (21).

23. The baler according to claim 17,
characterized in that
a cover element (27) is provided which extends from the upper edge of the storage slide (24) in the direction away from the filling opening (2.2a) and closes the area between the rear side of the storage slide (24) and the part of the storage container (21) adjacent thereto as viewed in plan view.

24. The baler according to claim 17,
characterized in that
the bottom (21a) of the storage container (21) rises filling opening upward, in particular as a flat surface, toward the filling opening (2.2a), in particular toward its lower edge,
the feed direction (24′) of the storage slide (24) runs parallel to the bottom (21a) of the supply container (21),
the front side (24a) of the storage slide (24) is arranged parallel to the inner surface of that side wall (2.2) in which the filling opening (2.2a) is located.

25. The baler according to claim 11,
characterized in that
the storage container (21) is attached to the press box (2) so as to be displaceable in height up to an upper position in which the box-side edge of the bottom (21a) is aligned with the lower edge of the filling opening (2.2a) or lies higher.

26. The method of operating a baler (1) according to claim 11,
whose press box (2) is filled automatically,
characterized in that
the press box (2) is filled automatically in batches.

27. Method according to claim 26,
characterized in that
the, in particular loose, material to be pressed (P) is automatically pressed, in particular pushed, through the filling opening (2.2a) into the press box (2).

28. The method according to claim 27,
characterized in that
the, in particular loose, material to be pressed (P) is compressed in height, i.e. precompressed, before or during pressing into the press box (2) through the filling opening (2.2a) to a height which is equal to or less than the height of the filling opening (2.2a).

29. The method according to claim 27,
characterized in that
the, in particular loose, material to be pressed (P) before it is pressed into the press box (2) through the filling opening (2.2a) is
either distributed over a smaller width considered in the top view than the width of the filling opening (2.2a),
or before or during pressing into the press box (2) through the filling opening (2.2a) is compressed in width to a width which is smaller than the width of the filling opening (2.2a).

30. The method according to claim 27
characterized in that
during pressing of the material to be pressed (P) in the press box (2)
a collector trolley (SW) can still be moved back into the docking position by the lift-tilt device (22),
in particular a new, filled collector trolley (SW) can be attached to the lift-tilt device (22), and/or
the storage container (21) of the filling device (20) can already be refilled with material to be pressed (P).

31. The method according to claim 27,
characterized in that
the, in particular loose, material to be pressed (P) is pushed upwards through the filling opening (2.2a) to the height of the filling opening (2.2a) before being pressed into the press box (2).

32. The method according to claim 27,
characterized in that
the, in particular loose, material to be pressed (P) is lifted upwards through the filling opening (2.2a) to the height of the filling opening (2.2a) before being pressed into the press box (2).
